(19) United States
(12) Patent Application Publication
(10) Pub. No.: US 2010/0070492 A1
(43) Pub. Date: Mar. 18, 2010

(54) SYSTEM AND METHOD FOR RESUME VERIFICATION AND RECRUITMENT

(75) Inventors: SANJAY DATTATRI, Chennai (IN); Athmaraman Rajagopalan, Chennai (IN); Ravi K.R. Kannan, Chennai (IN)

Correspondence Address: SANJAY DATTATRI;603, Flat C, Swathi Apartments, 29th Cross Street,, INDIRA NAGAR, CHENNAI, 600020, IN

(73) Assignee: Kelsa Info Comm Services Private Limited, Chennai (IN)

(21) Appl. No.: 12/241,049

(22) Filed: Sep. 30, 2008

(30) Foreign Application Priority Data
Sep. 17, 2008 (IN) 2254/CHE/2008

(51) Int. Cl. G06F 7/06; G06F 17/30

(52) U.S. Cl. 707/722; 707/E17.014

(57) ABSTRACT

A method and system for matching a candidate with prospective employers is provided. The system includes a web-based career management system having an input node for receiving candidate inputs from the candidate, and receiving employer inputs from an employer. The web-based career management further includes an expert processing system for receiving candidate inputs and employer inputs and for applying a plurality of analytics on the candidate inputs and the employer inputs to produce one or more analytics results. An output node is used for communicating the one or more analytics with the candidate and/or the employer. The candidate inputs include a resume, and one of the analytics results is a credibility score for a respective resume.

This application is related to and takes priority from an earlier foreign filed application number 2254/CHE/2008, filed in India on 17 Sep., 2008.

### BACKGROUND

The invention relates generally to the field of job search and candidate search and more specifically to a method and system for providing quantitative and qualitative ratings and scores for resumes and a reliable method and system for matching the candidate with prospective employers.

Currently, most jobsites provide a way to search through a resume database using various options. However, when one is searching for candidates with more commonly available skills, the search results may contain, literally, thousands of candidates. Short-listing from such a large number becomes a tedious and mostly a random-selection task. Usually the employer just picks the top 100 or so, instead of painstakingly going through all of them. Thus the current systems and methods do not efficiently provide a reliable match between the candidate and the job.

Similarly, when an employer advertises for a job opening, a shockingly high number of applications received for the advertised job opening are found to be completely unsuitable. Some industry studies suggest that the number of unsuitable applications could be as much as 80%. Therefore, more and more companies are shying away from posting job vacancies, both on job sites as well as on traditional media like newspapers and journals because of the difficulties in managing respondents.

Another issue with posting resumes on currently available online jobsites is the proliferation of falsified resumes in their database. Candidates falsify their resumes for various reasons, from wanting to hide their identity, to trying to deceive a potential employer into making them an offer or simply to come up higher in the search results in order to be short-listed by a potential employer. Not only do these falsified resumes dilute the quality of the entire database, they also make it that much more difficult for genuine candidates to be found by the employers.

Thus there is a need for a more reliable and robust system for job and candidate search that can ensure data correctness in a resume and also obtain better job-match results.

### BRIEF DESCRIPTION

According to one aspect of the invention, a web-based career management system is disclosed having an input node for receiving candidate inputs from the candidate, and receiving employer inputs from an employer. The web-based career management further includes an expert processing system for receiving candidate inputs and employer inputs and for applying a plurality of analytics on the candidate inputs and the employer inputs to produce one or more analytics results. An output node is used for communicating the one or more analytics with the candidate and/or the employer. The candidate inputs include a resume, and one of the analytics results is a credibility score for a respective resume.

According to another aspect, a method for validating a resume corresponding to a candidate in the web-based career management system is also disclosed. The method includes calculating a quantitative score, where the quantitative score is a function of a plurality of verified data points of the resume and a plurality of connections of the candidate with one or more individuals, where the candidate and the one or more individual have at least one shared attribute. The method further includes calculating a qualitative score, where the qualitative score is a function of plurality of parameters derived from the plurality of connections. Finally, the method includes, calculating a credibility score for the candidate based on the quantitative score and the qualitative score, where the credibility score is an indicator of the authenticity of records in the resume.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of the web-based career management system according to an exemplary embodiment;

FIG. 2 is a flowchart representing exemplary steps for a method for managing the resume using the web-based career management system of FIG. 1;

FIG. 3 is a diagrammatic representation of an expert processing system of FIG. 1;

FIG. 4 is a diagrammatic representation of exemplary inputs received by a input node of FIG. 1;

FIG. 5 is a diagrammatic representation of an exemplary dynamic employer output as displayed at an output node of the FIG. 1;

FIG. 6 is a diagrammatic representation of an exemplary dynamic candidate output as displayed at an output node of the FIG. 1; and

FIG. 7 is a diagrammatic representation of one aspect showing an exemplary computer system for implementing the web-based career management system of FIG. 1 and the method steps of flowchart of FIG. 2.

### DETAILED DESCRIPTION

The embodiments described herein refer to a reliable system and method for matching candidate's profile as given in a resume with an employer's requirements. The system in an exemplary embodiment is a web-enabled or web-based career management system. “Web-enabled” or “web-based” as used herein means a system that can access information through the internet and that can be accessed by candidates, employers, recruiters, and other web-based resources, through the internet (the term employer is intended to include any organization, individual, recruitment agency and the like who are engaged in an activity related to job-posting or job-hiring). “Jobsite” as referred herein means an online or web-enabled portal for posting resume and job requirements and for searching a suitable job or candidate.

The web-based career management system as described in an exemplary embodiment disclosed herein, typically resides in server or server(s) providing database storage, processing capability, access, and security. The web-based career management system also provides for interaction with other server-based applications such as e-mail services, credit/debit card processing, and accounting, reporting and statistical functions.

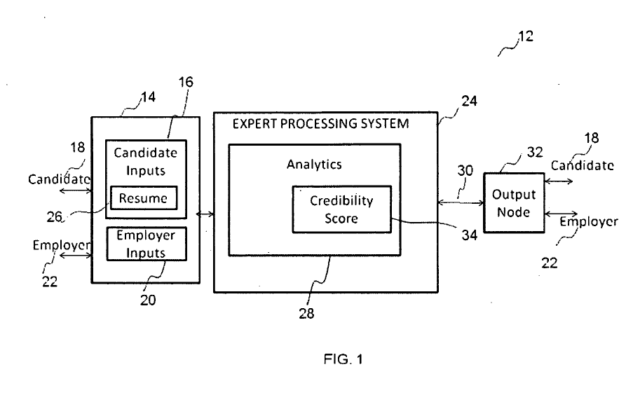

Referring now to drawings, FIG. 1 is a broad schematic for the exemplary embodiment of the web-based career management system 12. The system 12 includes an input node 14 for receiving candidate inputs 16 from the candidate 18, and receiving employer inputs 20 from an employer 22. The system 12 further includes an expert processing system 24 for using candidate inputs 16 (example a resume 26, ‘resume’ as used herein means one or more resume, bio-data, candidate profile, depending on the context) and employer inputs 20 and for applying a plurality of analytics 28 on the candidate inputs 16 and the employer inputs 20 to produce one or more analytics results 30. The system 12 further includes an output node 32 for communicating the one or more analytics results 30 with the candidate 18 and/or the employer 22. In the exemplary embodiment at least one of the analytics results 30 is an overall credibility score 34 for a respective resume 26.

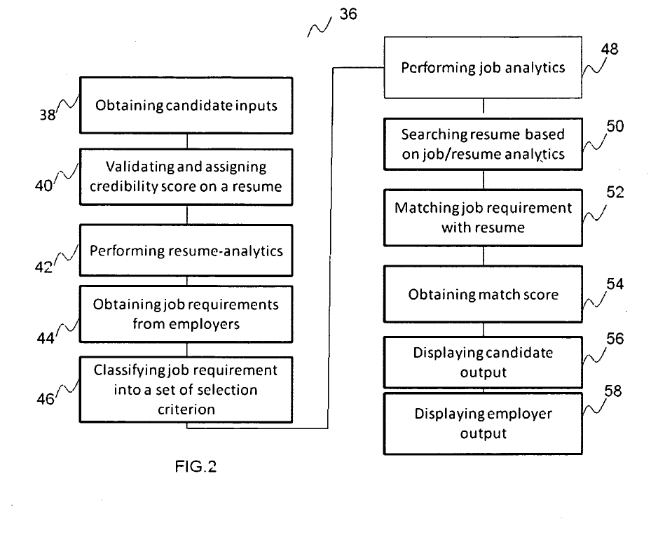

The overall functioning of the system 12 can be explained with reference to the flowchart 36, as shown in FIG. 2. Referring now to the flowchart 36, the method for candidate and job search using the web-based career management system of FIG. 1, includes a step 38 for obtaining candidate inputs, for example a resume in a predefined format from candidates, each resume corresponding to a single candidate. Another exemplary candidate input is a voice print, that is a record of candidate's voice that is provided to the employer during an interview process. At step 40, the system 12 validates the resumes and assigns a credibility score for each resume. At step 42, resume-analytics are performed by the system 12 on the resumes based on a variety of candidate criteria. Non-limiting examples for the candidate criteria may include a preference of job, nature of assignment, employer, industry or salary expectation. At step 44, the system 12 obtains job requirements from employers, each job requirement corresponding to a respective job. At step 46 the job requirements are classified into a set of selection criterion. At step 48, the system 12 performs job-analytics on the classified job requirements. At step 50, the resumes are searched based on the resume-analytics and the job-analytics. At step 52 the system 12 matches the job requirement and the selection criterion with one or more resume, and step 54 a match-score is obtained for each matched resume. Step 56 involves displaying a dynamic candidate output for view and use by the candidate and step 58 involves displaying a dynamic candidate output for view and use by the employer. It may be noted that the steps described herein are exemplary steps to explain the functioning of the career management system 12, and these steps do not indicate any preferred sequence of instructions.

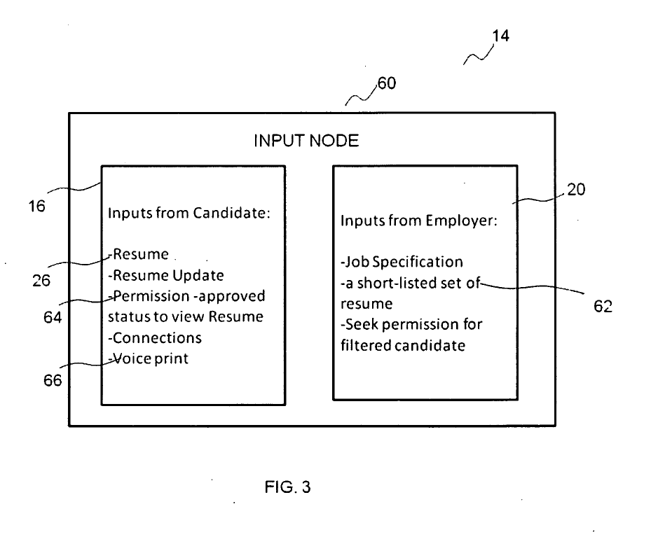

FIG. 3-6 illustrate the different components of the web-based career management system 12 and their individual functioning covering different steps of the flowchart 36 as described herein above.

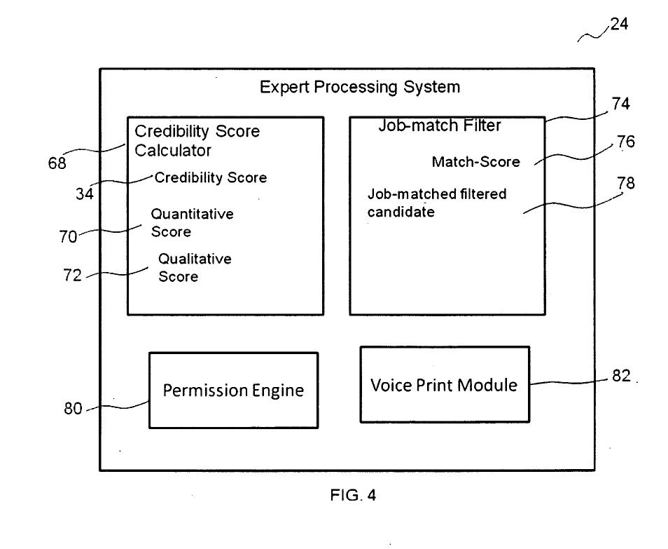

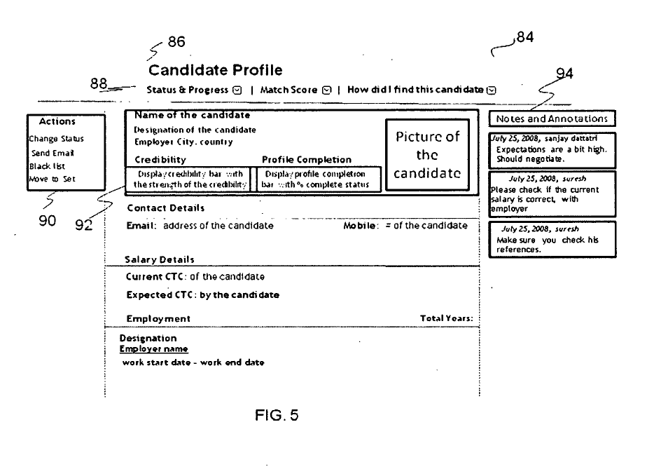

FIG. 3 describes an exemplary list 60 of inputs received by the input node 14 as the candidate inputs 16 and the employer inputs 20. The input node 14 receives the resume 26 in a predefined format (predefined format as used herein means a format made available to the candidate from the web-based career management system, as a form with a set of fields for which the candidate needs to provide information) from the candidate, and also any additional information sought by the expert processing system (shown in FIGS. 1 and 4). In a specific embodiment, the resume may not be needed in a predefined format from the candidate, and the expert processing system can extract information from any textual resume and place it in any required format as required by the expert processing system (shown in FIGS. 1 and 5) for processing and analytics purposes. The candidate inputs 16 may also include information pertaining to a preference of field of job being sought, a list of preferred organizations as prospective employers, from the candidate.

Similarly, the input node receives employer input 20, non-limiting examples of which include the job posting, job specification, ideal candidate profile. The employer input 20 also includes a short-listed set 62 of resume from the employer after the job-match search is done (step 52 and 54 for FIG. 2 and also explained in reference to FIG. 4).

The input node 14 also seeks permission-approved status 64 or tag from the respective candidate(s) for these short-listed set 62 of resume. This may be done via an email-communication with the candidate. Only when the candidate allows permission-approved status 64, the resume 26 can be viewed by the employer for further decision making.

In a specific embodiment, the input node 14 also receives a voice print 66 of the candidate in order to authenticate/verify the candidate during the interview process by the employer. The interview process may involve a phone interview or an on-site interview. The voice print 66 is a record of random sentences in the candidate's voice. The candidate is asked to repeat these sentences during the interview process and a match of the voice print is obtained. In case the voice of the candidate during the interview process does not match, the employer is notified and the interview is suspended and the incident is recorded against the candidate in his resume, affecting the candidate's credibility score 34. Such candidates may even be barred for posting their resume 26 in the web-based management system.

The input node also enables in another exemplary embodiment, using a job code received from the employer, where the candidates refer to the job code while posting their respective resumes. The job code may be advertised or notified by the employer on their respective job openings through any print or on-line media.

The inputs described herein above with respect to the candidate inputs and the employer inputs are exemplary inputs and non-limiting examples of the same. The input node may receive several other inputs related to the candidate, the job sought, employer, job-posting, job specification, as may be required for information processing and conducting analytics by the expert processing system 24 of FIG. 1 and described in more detail in reference to FIG. 4.

An exemplary embodiment of the expert processing system 24 is shown in FIG. 4. The expert processing system 24 processes the input information (candidate inputs and employer inputs received via the input node 14, as explained hereinabove in reference to FIG. 3), creates databases, and conducts analytics on the information. The input information is categorized in several categories to enable smooth and accurate retrieval of relevant information. The analytics performed by the expert processing system, and described herein below, provide a reliable and technical solution to help the candidate and the employer in their choice of a job and an employee respectively. The expert processing system also generates queries for interacting with the candidates and the employers. The term analytics as used herein means the analysis of the data and information using statistical and quantitative analytical methods, explanatory and predictive modeling, to assist in fact-based decision-making.

The expert processing system 24, in an exemplary embodiment includes a credibility score calculator 68 to generate the overall credibility score 34 by using a quantitative score 70 and a qualitative score 72.

The credibility score 34 is a measure of authenticity of the resume 26 of the candidate. ‘Authenticity’ as used herein means the ‘genuineness’ or ‘factual correctness’ of the information provided as part of the profile by the candidate. Candidates having a higher credibility score may generally be considered to be genuine candidates. The expert processing system 24 also provides suggested actions that are available to help candidates acquire a healthy credibility score. By actively increasing the credibility score, the candidates provide confidence to potential employers about their credentials as well as help the web-based career management system eliminate spurious and bogus profiles from the database. Thus the genuine candidates have an opportunity to build a healthy credibility score and at the same time, those candidates who try to falsify major sections of their profile are screened out. The credibility score does not reflect the candidate's capability, intelligence or fitness for any specific purpose. In other words, the credibility score is not a measure of candidate's qualification or suitability to any particular job.

The quantitative score 70 that is used to obtain the credibility score, is a function of verified data points of the resume and a function of different connections of the candidate with one or more individuals.

The verified data points are obtained by checking a set of records in the resume by the web-based career management system. The set of record may include an email id, address, phone number and the like corresponding to the candidate. For example, to obtain the verified data points the expert processing system 24 sends a first code to the email id listed on the resume by the candidate, the return mail by the candidate mentioning the first code, obtains a verified data point for the email id. A second code may be sent by the expert processing system 24 as an sms to the mobile contact number, the return sms by the candidate mentioning the second code, obtains a verified data point for the mobile phone contact number for the candidate. The expert processing system 24 also sends reminders to the candidate if any of the relevant data pertinent to the selection criteria is unavailable in the data in the resume.

With respect to the connections, the candidate and the one or more individual tagged as a ‘connection’ have at least one shared attribute, for example shared (meaning ‘same’ or ‘common’) educational institute (school, college, university) or shared workplace. For example, the candidate is required to connect to as many of his/her classmates and (ex) colleagues as possible through the web-based career management system. A connection is established between the candidate and one of his/her (ex) colleagues when either the candidate/colleague initiates a connection through the web-based career management system and the other party accepts that connection and the profiles of the two reflect the fact that they worked together at some point in time. Similarly, a connection between the candidate and one of his/her classmates is possible only if both their profiles reflect the fact that they studied together in the same school/college/educational institute. In case, the web-based career management system does not find a common attribute between the candidate and the individual, then the connection is not established.

The qualitative score 72 is a function of different parameters derived from the different connections. These parameters may include nature of each respective connection, credibility of the plurality of connections, and any combinations thereof. These parameters are derived from assessing the connections and their relationship with the candidate, including but not limited to feedback about the candidate.

A high-value credibility score ensures that the corresponding candidate comes higher up in the search results thereby dramatically improving the “rank” within the web-based career management system. The credibility score is made available on any suitable scale, for example from 0 to 100, wherein a score closer to 0 represents a low value and generally means low authenticity, while a score closer to 100 represents a high value and generally means greater authenticity. Accordingly, a rank may also be developed, wherein the highest score may be ranked as number 1, while the lowest score is ranked the last rank, and all intermediate scores are ranked according to their position.

Thus the expert processing system 24 provides a novel mechanism for having a high quality resume database, that is able to weed out falsified resumes, and also provides legitimate means for candidates to differentiate themselves from others and stand a good chance of being found by employers.

The expert processing system 24 further includes a job-match filter 74 in the exemplary embodiment, for matching the employer's specifications with the resumes and generating a match-score 76 for each job-matched filtered candidate 78. The employer's specifications (received as employer inputs) include a set of selection criterion for a respective job requirement. The match-score is an indicator of relevance or suitability of the resume (candidate) to the respective job requirement. The match-score thus quantifies the level of match between a job description and a candidate profile. Thus, for example, the employer can choose candidates with a match-score in the top 20 percentile and these would be close to the ideal candidate desired.

In the exemplary embodiment, the employers or recruiters only receive the number of matching resumes based on the match-scores, at this stage. No part of the candidate profile is made available to the employer yet.

The expert processing system 24 further includes a permission engine 80 for allowing the employer to view the resume based on the candidate's approval. Thus once the employer has narrowed down their field of interest to a selected set (or short-listed set as mentioned in reference to FIG. 2) of candidates, the expert processing system 24 sends an email/notification to the candidate giving details of the company and job, and seeks permission-approved on the candidate profile by the candidate. When the candidate is sure that he/she would like to pursue a particular job offer, the candidate provides the permission-approved status that is received by the expert processing system 24 (via the input node), and that particular employer is allowed full access to the candidate's profile for a period of time as selected by the candidate.

The expert processing system advantageously uses permission-based viewing of resume, where the candidate provides permission to view his resume based on his interest in a job position posted by the employer. Thus, nobody can find the candidate based on name, email, phone number or any other detail, this helps in reducing the number of spams received by the candidates. Also, many candidates are understandably wary of being seen/found on a job site. Some of the reasons include avoiding being seen by current employer, avoid letting others know that the candidate is looking for a job. From the employer's perspective, it is advantageous as by specifically asking for a candidate's permission the expert processing system 24 ensures that the employer does not waste time and resources trying to contact candidates who may have no intention of joining the employer.

The expert processing system 24 further includes a voice print module 82 for recording voice of a candidate as a voice print 66, the voice print 66 serves as an authentication tool during the interview, as explained in reference with the discussion of FIG. 3.

It may be appreciated that the analytics described herein as credibility score, match-score, permission-approved status, are some non-limiting examples of the analytics. The expert processing system 24 also performs several other analytics based on different analytics criterion to filter search results for matching candidates and matching job postings. These analytics enable a user (candidate or employer or recruiter, for example) to slice and dice the information in the input node and in the expert processing system.

The results of the analytics (analytic results) performed by the expert processing system 24 are available through the output node 32 (FIG. 1). Thus output node includes a variety of display of value-added information in form of statistics, or graphical output or text display. The output node, for example includes a display of the resume-analytics and job-analytics for viewing by the candidate and by the employer.

An example of employer-analytics and its output is described as follows. With respect to a particular job posting by the employer, a thousand of candidates specified their expected salary to be around what the employer has specified. 500 of them possessed the skills identified by the employer as part of the employer's top three skills requirement. 300 of them were already working in the city of preference of the employer (job location) and a further 700 specified the employer's preferred city as their preferred place of work. As would be appreciated by one skilled in the art, this filtering technique still results in a lot of resumes to go through by the employer. The analytics through the expert processing system allows the employer to slice and dice the selected profiles across over at least 40 different criteria and the results are available swiftly through the display at output node 32. This additional information helps to further narrow down the search field until a perfect match is obtained for the job/candidate.

Additionally the employer is able to see analytics results not only on the resume database as a whole, but also on the respective respondent data. At a glance, the employer can know exactly what kind of candidates have responded to the job posting and which ones appear to be more suitable than others.

Further, in case the expert processing system requires additional information for any of the analytics, the output node communicates the specific information that is required to the candidate. If the expert processing system has filtered candidates for a particular job, then the output node communicates the job specification and employer information to the filtered candidate. The output node communicates to the employer the list and the resumes of all the candidates who have allowed viewing of the resume. The employer shortlists the candidates of choice and communicates the same through the input node. The expert processing system, updates the records in the database and communicates the decision of the employer to the candidates of choice and those not short-listed.

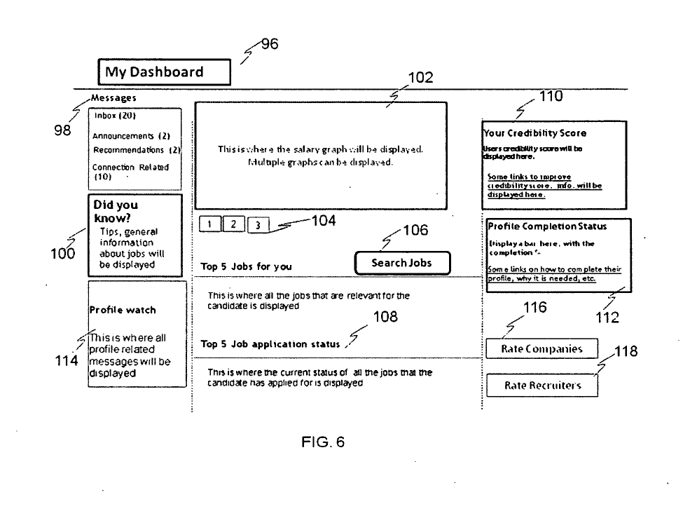

FIG. 5 and FIG. 6 illustrate exemplary outputs for the employer (dynamic employer output) and candidate (dynamic candidate output) respectively. These are merely for illustrative purpose. The outputs are dynamic in nature meaning that the outputs are changed, updated and are not static and several other outputs may be made available based on the requirements of the candidate and the employer.

An exemplary output 84 for use by the employer is shown in FIG. 5. The employer-output 84, includes a display of information about candidates, for example a candidate profile 86 that shows tabs 88 giving status and progress of the candidature, match-score with respect to this candidate and information on how the employer arrive at this candidate which could be through a referral or an print advertised post or through the web-based career management system. The display also includes a snapshot on actions with respect to this candidate as shown by reference numeral 90. Reference numeral 92, indicates data with respect to the candidate like the candidate's credibility score, contact address, salary details, work profile. It may include his skill-sets, his preferences and similar other information. The display for the employer may also includes value-added notes and annotations, shown as reference numeral 94 that help in decision making for the recruitment of the candidate. Another exemplary output for the employer includes the candidate's profile annotated with additional relevant information against each section of the profile. These annotations include system generated information as well as notes and observations jotted down by predecessors in the recruitment process. For example, right next to the candidate's salary details a graph is provided that shows the prevailing market salaries for a person of comparable skills and experience with the expectations of the candidate clearly marked out. Similarly against each of the employment records, the employer can view details of the candidate's credibility scores. These and many other annotations help to guide the employer to look at specific sections of the profile so that during interviews the candidate may be scrutinized in the right areas.

Another exemplary output 96 for use by the candidate as “My Dashboard” is shown as FIG. 6. The candidate can view messages with respect to his resume as shown by reference numeral 98. This would include items like an inbox to receive emails related to his job-interest or queries with respect to his resume, any announcements and recommendations, or any information related to his connections. The candidate also receives information that maybe of interest to him with respect to his career, this is indicated generally by the reference numeral 100. The window shown generally as reference numeral 102, may include a graphical display of different statistics, for example salary distribution of similar experience professionals in a particular job profile of interest to the candidate. The display further includes a listing of top jobs for the candidate as shown by the reference numeral 104. The candidate may further do a bob search through the window 106. The candidate also receive a dynamic status of his applications in the various job positions where he was short-listed, this is shown at 108. Candidate's credibility score and profile completion status is displayed at 110 and 112 respectively. The candidate can then take informed decision to improve the score and complete the profile accordingly. The display further includes tabs 114 and 116 that allow the candidate to rate companies and recruiters respectively, based on his experience.

The aforementioned displays and outputs for the candidates and the employers are shown by way of example only and are non-limiting examples. As it will be appreciated by one skilled in the art, there are several other features that may be obtained using the analytics performed by the expert processing system that help in making the right match between the candidate and the employer, and are included in the scope of the invention.

Thus the web-based career management system works like a personal career manager by actively pursuing potential opportunities that match the candidate's profile, respond to potential employers' queries without divulging details of the candidate, inform the employers' that the candidate is interested in the job, and provide the different analytics for the jobs.

It may be noted that the web-based career management system, the expert processing system and its components, input and output nodes as used herein are intended as generic terms for the combination of computer hardware, software and communication means (computer system), of different aspects of the web-based career management system. The method and process steps and algorithms described herein can be executed by means of software running on a suitable processor, or by any suitable combination of hardware and software. When software is used, the software can be accessed by a processor using any suitable reader device which can read the medium on which the software is stored. The computer readable storage medium can include, for example, magnetic storage media such as magnetic disc or magnetic tape; optical storage media such as optical disc, optical tape, or machine readable bar code; solid state electronic storage devices such as random access memory (RAM) or read only memory (ROM); or any other physical device or medium employed to store a computer program. The software carries program code which, when read by the computer, causes the computer to execute any or all of the steps of the methods disclosed in this application.

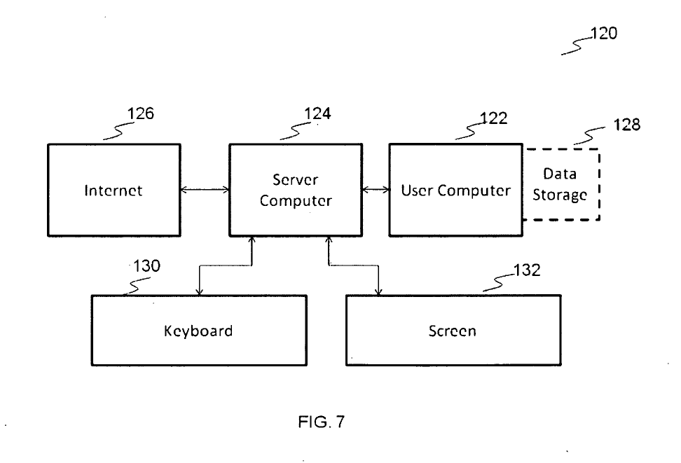

FIG. 7 is a block diagram 120 of one exemplary embodiment illustrating the computer systems for implementing the web-based career management system of FIG. 1 and method of FIG. 2. As shown, a user computer 122 (user may include a user for the web based career management system or a candidate or an employer or recruiter or any other interested party) that may be linked to another computer 124, such that the computers 122 and 124 are capable of sending information to each other and receiving information from each other. In one embodiment, computer 124 could comprise a server computer adapted to communicate with a network 126, such as, for example, the Internet. Computers 122 and 124 can be linked together in any conventional manner including a modem, hard wire connection, or fiber optic link. Generally, information can be made available to both computers 122 and 124 using a communication protocol typically sent over a communication channel, or through a dial-up connection or ISDN line or any such suitable means. Computers 122 and 124 are generally adapted to utilize program storage devices embodying machine readable program source code which is adapted to cause the computers 122 and 124 to perform the method steps as described in reference to FIG. 2. The program storage devices incorporating features of the present invention may be devised, made and used as a component of a machine utilizing optics, magnetic properties and/or electronics to perform the procedures and methods as described in reference to FIGS. 2-6. Computers 122 and 124 may also include a microprocessor for executing stored programs. Computer 122 may include a data storage device 128 on its program storage device for the storage of information and data. The computer program or software incorporating the processes and method steps as mentioned in reference to FIG. 2-6, may be stored in one or more computers 122 and 124 on an otherwise conventional program storage device. In one embodiment, computers 122 and 124 may include a user interface 130, such as, for example, keyboard and a display interface 132, such as for example a screen. In alternate embodiments, any suitable user interface and display interface can be used from which features of the present invention can be accessed. The user interface 130 and the display interface 132 can be adapted to allow the input of queries and commands to the system, as well as present the results of the commands and queries.

Embodiments described herein are exemplary embodiments and a variety of alternative embodiments of the career management system can be employed in other commercial and industrial setting where there is a requirement for a self induced data verification, data analytics and delivery system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A web-based career management system, the system comprising:
an input node for receiving candidate inputs from the candidate, and receiving employer inputs from an employer;
an expert processing system for receiving candidate inputs and employer inputs and for applying a plurality of analytics on the candidate inputs and the employer inputs to produce one or more analytics results; and
an output node for communicating the one or more analytics with the candidate and/or the employer,
wherein candidate inputs comprises at least a resume, and wherein at least one of the one or more analytics results is a credibility score for a respective resume.

2. The system of claim 1, wherein the expert processing system further comprises:
a credibility score calculator to generate the credibility score by using a quantitative score and a qualitative score, wherein the credibility score is a measure of authenticity of the resume of the candidate.

3. The system of claim 1, wherein the expert processing system further comprises:
a job-match filter for matching the employer's specifications with a plurality of resumes and generating a match-score for each job-matched filtered candidates.

4. The system of claim 1, wherein the expert processing system further comprises:
a permission engine for allowing the employer to view a resume based on the candidate's approval.

5. The system of claim 1, wherein the expert processing system further comprises:
a voice print module for recording voice of a candidate as a voice print, wherein the voice print serves as an authentication tool during the interview.

6. A method for managing resumes using a web based career management system, the method comprising:
obtaining resumes in a predefined format, each resume corresponding to a single candidate;
validating resumes and assigning a credibility score for each resume;
performing resume-analytics on the resumes based on a plurality of candidate criterion;
obtaining job requirements from employers, each job requirement corresponding to a respective job;
classifying the job requirements into a set of selection criterion;
performing job-analytics on the classified job requirements;
searching the resumes based on the resume-analytics and the job-analytics;
matching the job requirement and the selection criterion with one or more resume;
obtaining a match-score for each matched resume;
displaying a dynamic candidate output for view and use by a candidate;
displaying a dynamic employer output for view and use by the employer;
seeking permission-approved for resume viewing from the candidate on a short-listed set of resume by the employer; and
displaying the permission-approved resume to the employer.

7. The method of claim 6 further comprising obtaining a voice print of a candidate; and
using the voice print to verify the candidate during an interview process by the employer.

8. The method of claim 6, wherein the step of validating resumes and assigning a credibility score for each resume comprises:
calculating a quantitative score, wherein the quantitative score is a function of a plurality of verified data points of the resume and a plurality of connections of the candidate with one or more individuals, wherein the candidate and the one or more individual have at least one shared attribute;
calculating a qualitative score, wherein the qualitative score is a function of plurality of parameters derived from the plurality of connections; and
calculating the credibility score for the candidate based on the quantitative score and the qualitative score, wherein the credibility score is an indicator of the authenticity of records in the resume.

9. The method of claim 8 wherein the plurality of parameters comprise nature of each respective connection, credibility of the plurality of connections, and any combinations thereof.

10. The method of claim 8 wherein the at least one shared attribute includes a common workplace or a common educational institute.

11. The method of claim 6 wherein generating the match-score comprises:
comparing the resumes with a set of selection criterion for a respective job requirement; and
generating the match-score as an indicator of relevance of the resume to the respective job requirement.

12. The method of claim 6 further comprising displaying the resume-analytics and the job analytics for viewing by the candidate and by the employer.

13. A computer program product comprising: a computer useable medium having a computer readable code including instructions for:
obtaining resumes in a predefined format, each resume corresponding to a single candidate;
validating resumes and assigning a credibility score for each resume;
performing resume-analytics on the resumes based on a plurality of candidate criterion;
obtaining job requirements from employers, each job requirement corresponding to a respective job;
classifying the job requirements into a set of selection criterion;
performing job-analytics on the classified job requirements;
searching the resumes based on the resume-analytics and the job-analytics;
matching the job requirement and the selection criterion with one or more resume;
obtaining a match-score for each matched resume;
displaying a dynamic candidate output for view and use by a candidate;
displaying a dynamic employer output for view and use by the employer;
seeking permission-approved for resume viewing from the candidate on a short-listed set of resume by the employer; and
displaying the permission-approved resume to the employer.

14. The computer program product of claim 13, wherein the instructions further comprising
obtaining a voice print of a candidate; and
using the voice print to verify the candidate during an interview process by the employer.

15. The computer program product of claim 13, wherein the instructions further comprising

16. The computer program product of claim 13, wherein the instructions further comprising
calculating a quantitative score, wherein the quantitative score is a function of a plurality of verified data points of the resume and a plurality of connections of the candidate with one or more individuals, wherein the candidate and the one or more individual have at least one shared attribute;
calculating a qualitative score, wherein the qualitative score is a function of plurality of parameters derived from the plurality of connections; and
calculating the credibility score for the candidate based on the quantitative score and the qualitative score, wherein the credibility score is an indicator of the authenticity of records in the resume.

17. The computer program product of claim 16, wherein the plurality of parameters comprise nature of each respective connection, credibility of the plurality of connections, and any combinations thereof.

18. The computer program product of claim 16 wherein the at least one shared attribute includes a common workplace or a common educational institute.

19. The computer program product of claim 13, wherein the instructions further comprising:
comparing the resumes with a set of selection criterion for a respective job requirement; and
generating the match-score as an indicator of relevance of the resume to the respective job requirement.

20. The computer program product of claim 13, wherein the instructions further comprising:
displaying the resume-analytics and the job analytics for viewing by the candidate and by the employer.
